(19) United States
(12) Patent Application Publication
(10) Pub. No.: US 2006/0243768 A1
(43) Pub. Date: Nov. 2, 2006

(54) Compact beverage and article caddy for luggage

(76) Inventor: Douglass Dowell, Tampa, FL (US)

Correspondence Address: Ralph A. Dowell of DOWELL & DOWELL P.C., 2111 Eisenhower Ave, Suite 406, Alexandria, VA, 22314, US

(21) Appl. No.: 11/116,271

(22) Filed: Apr. 28, 2005

(51) Int. Cl. B60R 9/00; B60R 11/00

(52) U.S. Cl. 224/400; 224/572

(57) ABSTRACT

A compact article carrier or caddy that is specifically adapted to be mounted to the handle members of wheeled luggage, suitcases and related items, wherein the caddy includes a frame that supports a freely pivotal ring member in which a liquid containing container may be selectively placed so as to be vertically supported regardless of an angle of inclination of the handle members and wherein the frame may be collapsed for compact storage.

### BACKGROUND OF THE INVENTION

1. Field of the Invention

This invention is generally directed to compact article carriers or caddies for supporting beverage containers as well as other personal effects and more specifically to such devices that are particularly adapted to be quickly and easily mounted to pull out handles associated with luggage or baggage and other wheeled article carriers. The invention permits beverage containers to be supported vertically by the pull out handles regardless of an angle of inclination of the handles which angle varies as an article carrier is being used.

2. Brief Description of the Related Art

Over the years a variety of drink or beverage container caddies have been designed to be attached to wheeled and other article carriers to provide support for the containers in areas where conventional support surfaces, such as tables, are not available. Such caddies function in such a manner that a person is free to use their hands for other purposes.

By way of example, U.S. Pat. No. 6,390,431 to Ott discloses a beverage cup holder that is designed to be supported on a handle of a wheeled suitcase. The patent shows a cylindrical cup holding member that is supported by a spring clamp that is secured to the handle of the suitcase. Although a beverage container may be seated within the cup holding member of the patent, if the handle is inclined, such as when the suitcase is being pulled, the contents of any opened container could easily spill. Further, the structure disclosed is not compact and it would be difficult to store the cup holder in a person's carry on luggage or suitcase without taking up a significant amount of space. Somewhat similar beverage holders for use with hand pulled golf carts are disclosed in U.S. Pat. No. 5,152,489 to Christensen et al and U.S. Pat. No. 5,484,129 to Megal. However, the Patent to Megal pivotally mounts a beverage container engaging clamp relative to the golf cart so as to attempt to insure that the beverage remains vertical as the cart is moved. In the Patent to Christensen et al, the holder also provides support for other articles.

The problems associated with maintaining beverage containers vertically stable during movement of a vehicle or other wheeled article carrier have be addressed in U.S. Pat. No. 5,664,718 to Vine and U.S. Pat. No. 3,184,201 to Smith. Both Patents disclose generally circular beverage container supports that are pivotally mounted relative to an anchor member so that, when a beverage container is placed within the holder, the weight of the beverage container will retain the container vertically oriented and thereby prevent spills.

There remains, however, a need to provide beverage and other article carriers that not only have the self stabilizing feature of some prior art article carriers but that can be easily and compactly stored, when not in use, in a person's handbag, purse, carry on luggage and the like, so that the article carriers are always conveniently available for use.

### SUMMARY OF THE INVENTION

This invention is directed to beverage and other article carries or caddies that are specifically adapted to be mounted to extendable or retractable pull handles used with wheeled luggage or baggage. The caddies preferably include first and second pivotally connected frame components that may be compactly folded into a relatively overlaying relationship relative to one another so as to permit the caddies to be compactly stored, such as by being placed in a pocket or pouch associated with an article of luggage or the like.

A resilient connector is associated with the first frame component and is used to secure the first frame component to the pull handles after they have been extended. The connector may be in a form of an elastic band or an elastic strap, such as a bungee cord, having hook elements mounted at the opposite ends thereof. The bands, cords or straps are preferably used to securely retain the first frame component of the caddy to the extended members of the handle, however, in some embodiments, clamps or clips which are manually adjustable or which have spring loaded jaws may be used.

When the first frame component is secured to the luggage handle members, the second frame component is pivoted to a deployed position which is substantially perpendicular to the first frame component. In some instances, the second frame component may be oriented at an angle that is greater than 90° relative to the first frame component.

An article support or retaining ring is pivotally mounted within the second frame component so as to be freely movable with respect thereto so that the ring, when supporting the weight of an article therein, will maintain a horizontal orientation regardless of the angle of the handle members. The ring preferably has a diameter such that conventional beverage containers including coffee and cold drink cups, water, juice and related bottles and the like, may be conveniently supported therein. As the retainer ring maintains a horizontal orientation, any drink container supported therein will be less likely to spill as an individual pulls or pushes on the luggage handle to manipulate the luggage on the luggage wheels.

In some embodiments, the caddies of the present invention may include one or more article carrying pouches or pockets that are supportted on the second frame component on one or both sides of the article supporting ring. The side pocket or pockets may be used to support other articles that are frequently necessary to a traveler, business or other person using wheeled luggage and related wheeled article carriers. Such articles may include cellular phones, PDAs and other hand held computer devices, note pads, writing implements and the like. Such side pouches or pockets may or may not include covers or closures.

In some instances, a flexible pouch may also be secured within the article support ring. Such a pouch may be used to support containers such as bottles or cans which would otherwise be too small to be supported by the ring alone. Appropriate draw strings may be use with the flexible pouch to permit adjustment of an opening into the pouch.

When not in use, the caddies of the present invention may be quickly and easily compactly folded such that the two frame components and the support ring are generally parallel to one another. With such a compact configuration, the caddies may be easily placed within the luggage to which they are to be eventually mounted.

It is a primary object of the present invention to provide an article support device or caddy that can be easily mounted to the extendable handle members of wheeled luggage and other related article carriers to thereby provide a self-aligning support for containers housing liquids that may spill so that such containers are maintained generally vertical regardless of the angle of the luggage handle members as the luggage is being maneuvered.

It is a further object of the present invention to provide an article carrier or caddy that allows an individual using a wheeled suitcase, briefcase, backpack, tool case or other extendable or foldable handle luggage and article carriers to support containers of open liquids thereby leaving an individual's hands free for use in answering calls, presenting passes, tickets and identification documents or for taking notes in areas where no practical surfaces are available to otherwise support such containers.

It is another object of the present invention to provide a collapsible and compact article support or caddy that is specifically adapted to be mounted to elongated members associated with the handles of wheeled article carriers, such as luggage, wherein the caddy is designed to compactly fold for easy storage within the luggage to which the caddy is to be mounted when in use.

### BRIEF DESCRIPTION OF THE DRAWINGS

A better understanding of the invention will be had with reference to the accompanying drawings wherein:

FIG. 1 is a top perspective view of the compact luggage caddy of the invention showing the beverage support ring and side article carrying pouches;

FIG. 2 is a rear elevation view of the caddy of FIG. 1 showing side pouches expanded;

FIG. 3 is a front elevation view of the caddy of FIG. 1;

FIG. 4 is a side view of the caddy of FIG. 1;

FIG. 5 is a cross sectional view taken along line 5-5 of FIG. 1;

FIG. 6 is a cross sectional view taken along line 6-6 of FIG. 1;

FIG. 7 is a bottom perspective view illustrating the manner in which the luggage mounting frame folds relative to the article support frame of the invention;

FIG. 8 is a top plan view of the caddy of FIG. 1 compactly folded to facilitate storage;

FIG. 9 is an illustrational view of the caddy of FIG. 1 mounted to generally parallel members of a pull out handle of a suitcase or piece of luggage illustrating the manner in which the beverage container support ring of the caddy of the invention automatically pivots to maintain the beverage container vertically oriented regardless of the tilt angle of the handle members of the suitcase or piece of luggage;

FIG. 10 is a partial side view of a varied embodiment of the caddy mounted to a piece of luggage or a suitcase as shown in FIG. 9; and

FIG. 11 is a partial rear view of the caddy mounted to the handle members of the suitcase or piece of luggage shown in FIG. 9.

### DESCRIPTION OF THE PREFERRED EMBODIMENT

With continued reference to the drawing figures, the compact luggage caddy 20 of the invention will be described as being used to support a variety of articles such as a beverage container “C”, a cellular telephone “T” and pad of paper with pen “P” from pull out or extendable handle members “H1” and “H2” of a wheeled article carrier such a piece of luggage “L”. The caddy is specifically designed and constructed so as to be light in weight and capable of being compactly folded so as to be easily stored, when not in use, in an article carrier to which it may be mounted, when in use. It is the express purpose of the invention to provide a caddy that may be quickly and easily mounted on the handle members associated with substantially any wheeled article carrier including, but not limited to, luggage, suitcases, briefcases, tool kits, maintenance kits, portable sound and entertainment systems, computer carriers, back packs and the like.

Most people have, at some time during travel to or from jobs or job sites or when using public transportation, encountered the inconvenience of pulling a piece of luggage or the like while holding a beverage, such as a cup of coffee or a can or bottle of water, soda or other liquid, and receiving a cellular call or perhaps having to locate and produce identification or ticket information. Generally, there is no practical surface on which to place the beverage so that the person is free to use their hands to perform whatever function is necessary.

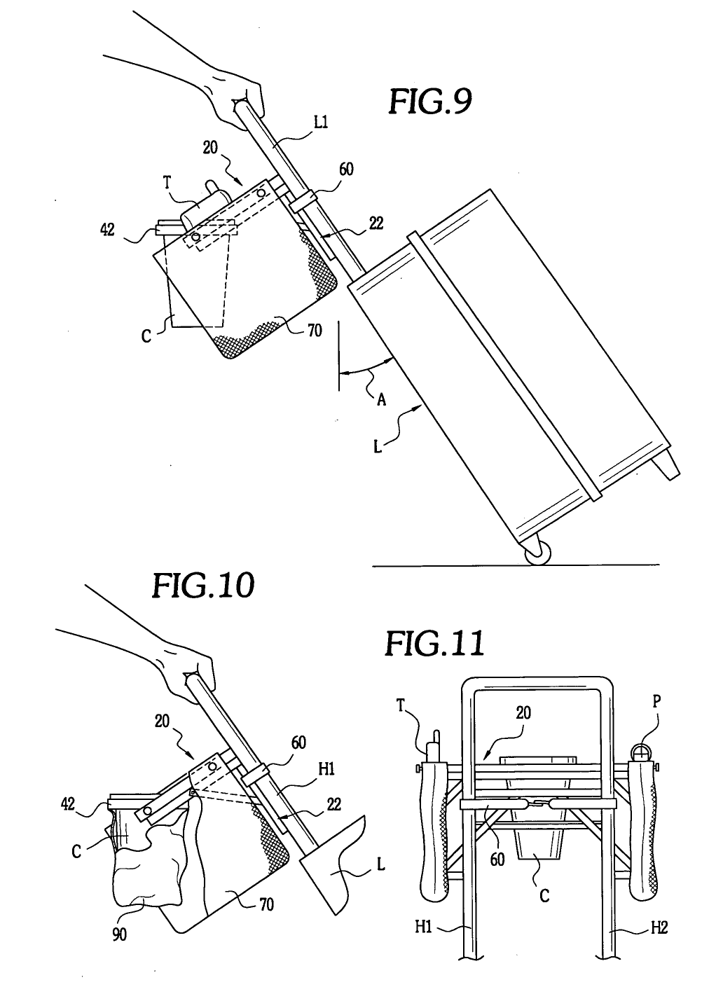

Using the caddies of the present invention, articles that would normally be hand carried or articles that would be stored within a piece of luggage are conveniently supported on the handles of the luggage so as to be readily available for use. Further, the caddies permit beverage containers to be support in such a manner that the contents of the containers will not spill as the luggage is being maneuvered, regardless of the angle of inclination “A” of the luggage handle members “H1” and “H2”, as is illustrated in FIGS. 9-11.

The caddy 20 includes a first frame component 22 having spaced handle member engaging portions 23 and 24. The portions 23 and 24 are connected by at least one cross brace 25 and may be further reinforced by diagonal struts 27,28 and 29,30. The exact configuration and structure of the first component may change as long as the first component creates surface portions for engaging with the handle members so that, when the caddy is mounted to the handle members, the caddy will be stabilized. A second article supporting frame component frame component 32 is mounted to the first component and, in the preferred embodiment, is pivotally mounted by pivot pins 33 and 34 to the first frame component. In this manner, the two primary structural elements of the invention may be easily and readily folded into a compact overlaying relationship relative to one another, as is shown in FIG. 8, to facilitate storage of the caddy in an article of luggage when not is use. The folding of the frame components and other parts of the caddy will be described in detail hereinafter.

Although the structure of the second frame component may vary, as shown, the second frame includes spaced side members 35 and 36 that are pivotally connected adjacent their inner ends to the first frame components. A pair of spaced bearing members 37 and 38 is secured to outer portions of the side members 35 and 36. The bearing members include oppositely facing recesses 39 in which bearing pins 40 associated with a beverage supporting ring 42 are freely pivotally seated so that the ring 42 is freely pivotally mounted to the second frame component 32. In this manner, when the caddy is mounted on the handle members “H1” and “H2” of the suitcase or piece of luggage “L”, a container “C” seated with the support ring 42 will always be maintained in a vertically upright orientation regardless of the angle of inclination “A” and the handle members.

The support ring 42 is preferably round having a diameter that is compatible with a diameter of conventional drink cups having tapered side walls such that when the cups are seated within the support ring, they are retained in place by friction. Other configurations for the support ring may also be used.

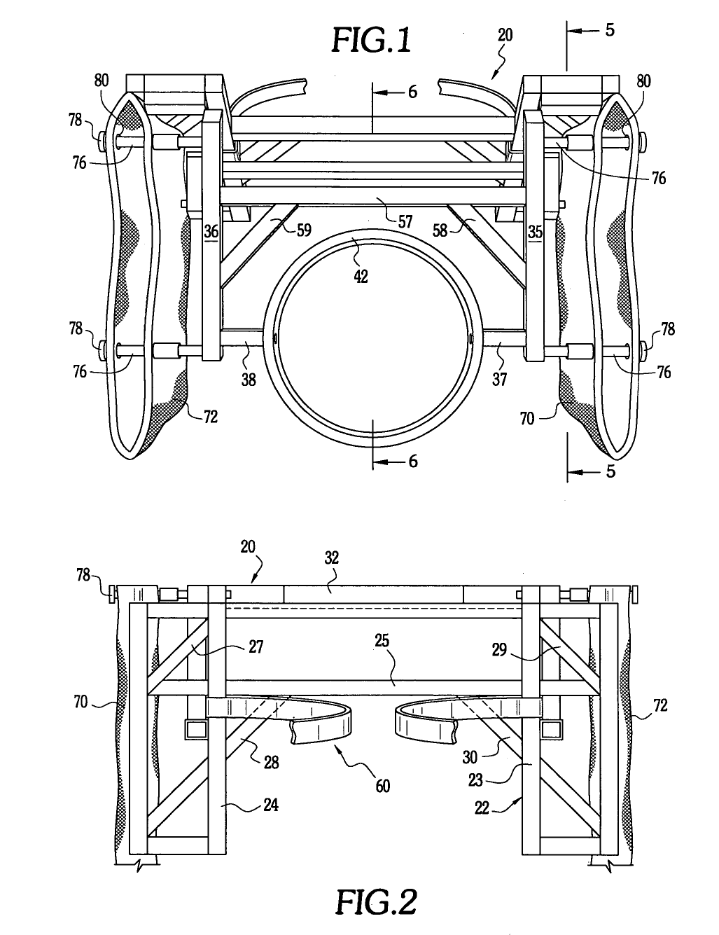

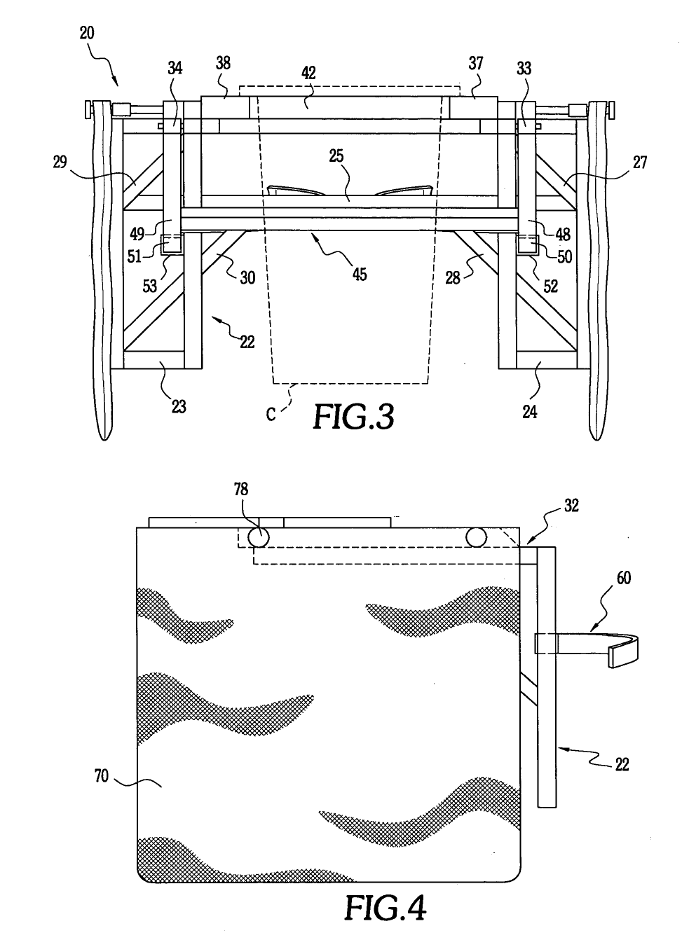

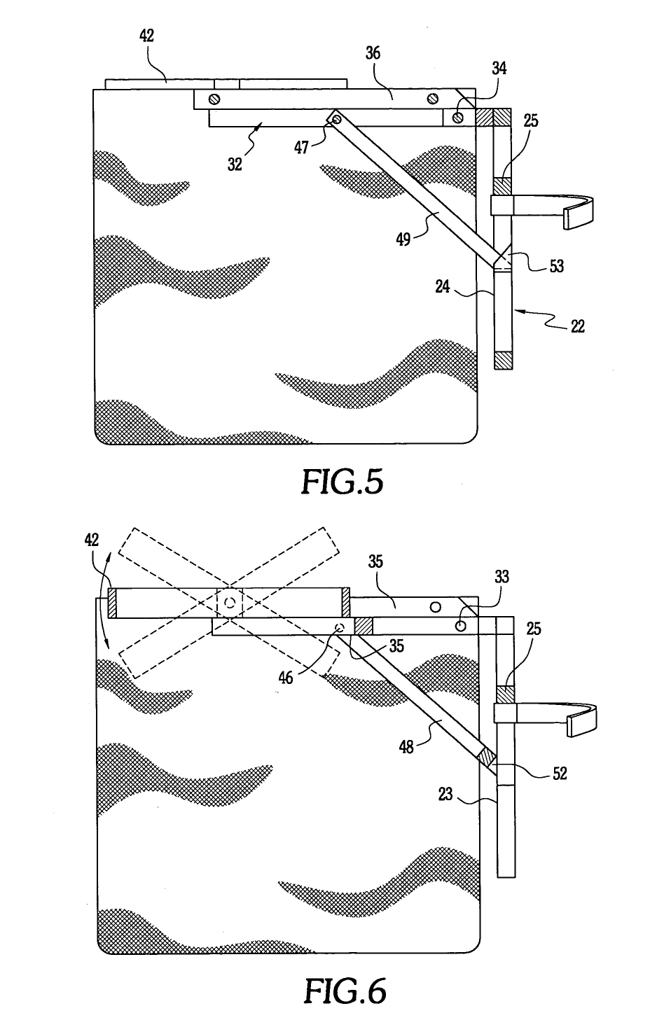

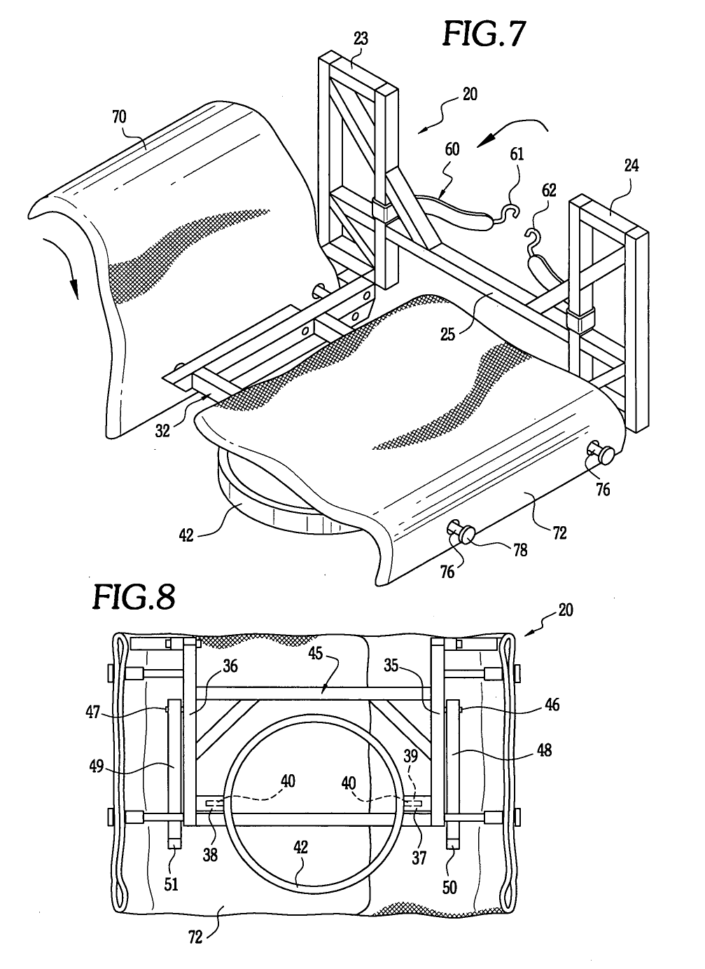

The second frame component is retained in the deployed position shown in FIGS. 1-3 by an elongated generally u-shaped brace 45 that is pivotally connected at 46 and 47 to the side members 35 and 36 thereof. The brace includes spaced arms 48 and 49 having free outer ends 50 and 51 that are selectively seated in brackets 52 and 53 mounted to the handle member engaging portions 24 and 23 of the first frame component 22. The brackets thereby support the brace to retain the second frame component in the deployed position. When the caddy is removed from an article of luggage, the caddy is easily folded into a compact configuration for storage. When the second frame component is pivoted slightly beyond 90° with respect to the first frame component, the free ends of the arms 48 and 49 of the u-shaped brace 45 are lifted from the brackets 52 and 53. With the brace disengaged from the brackets, the brace is pivoted so as to be coplanar with the second frame component, as is shown in FIG. 7. Thereafter, the first frame component and second frame component are pivoted relative to one another so that they are seated generally in overlaying relationship relative to one another, as is shown in FIG. 8.

As opposed to mounting the brace 45 to the second component 32, in some embodiments, the brace may be pivoted to the first frame component 22 and the brackets 52 and 53 mounted on the second frame component. The second frame component may be further reinforced by a cross member 57 that extends between the side members 35 and 36 as well as diagonal braces 58 and 59.

The caddy 20 may be mounted to the handle members “H1” and “H2” by using a variety of clips or clamps. However, and as shown in the drawings, a preferred manner of securing the caddy to the handle members is an elastic band or bungee strap 60. The strap has hooked ends 61 and 62 that are engageable with one another after the cord has been extended through the first frame component and about the handle members. The length of the cord is such that sufficient force will be directed against the handle members to retain the caddy in a mounted position to the handle members even when the caddy carries a beverage and other items.

The caddy may also be provided with one or more pouches or pockets 70 and 72 in which a variety of items may be selectively stored so as to readily available to a person using the caddy. Pairs of mounting pins 76 are secured to each of the side members 35 and 36 of the second frame component on which the pouches 70 and 72 are suspended. The pins are of sufficient length to allow the mouth of the pouches to be expanded, see FIG. 2, to facilitate placement of items within the pouches. Outer ends 78 of each pin are enlarged such that the pins will not easily slip through openings 80 in the pouches through which the pins extend when the pouches 70 and 72 are in use. Spacer sleeves 79 are mounted about each pin 76 and space the pouches from the pivotal frame components. The pouches are folded over one another intermediate the first and second frame components when the caddy is not in use, as is shown in FIGS. 7 and 8.

With particular reference to FIG. 10, a modified embodiment of the invention is shown. In this embodiment, a flexible pouch 90 is shown as being suspended from the beverage container support ring 42. The pouch is preferably removable mounted to the ring such as by use of snap fasteners or hook and loop material fasteners (not shown). The pouch is designed to support cans and other containers that would otherwise not frictionally seat within the ring 42. When not in use, the pouch 90 may be stored within one of the side pouches 70 and 72.

The caddies of the invention may be formed of any durable and light weight materials although plastic materials are preferred.

The foregoing description of the preferred embodiments of the invention has been presented to illustrate the principles of the invention and not to limit the invention to the particular embodiments illustrated. It is intended that the scope of the invention be defined by all of the embodiments encompassed within the following claims and their equivalents.

I claim:

1. An article support caddy for use with wheeled article carriers having extendable handle members, the caddy including, a first component, means for securing said first component to the extendable handle members extending from the wheeled article carrier, a second component, a generally annular article support member pivotally mounted to said second component about a horizontal axis when the caddy is mounted to the handle members such that an article seated with said generally annular article support member maintains a vertical orientation when the caddy is in use, said second component being pivotally connected to said first component such that said first and second components are movable from a compact overlaying relationship with one another to a deployed position wherein said second component extends transverse relative to said first component, and means for maintaining said second component in the deployed position.

2. The article support caddy of claim 1 wherein said means for maintaining includes a brace pivotally secured to one of said first and second components and means carried by the other of the first and second components to engage with said brace.

3. The article support caddy of claim 1 including at least one pouch carried by said second component in which articles may be selectively placed.

4. The article support caddy of claim 3 wherein said second component includes spaced side members and said generally annular support member being pivotally mounted between said spaced side members.

5. The article support caddy of claim 4 including at least two pouches carried by said second component, said pouches being mounted on opposite sides of said generally annular support member.

6. The article support caddy of claim 5 including a third pouch carried within said generally annular article support member.

7. The article support member of claim 1 including a pouch carried within said generally annular support member.

8. The article support caddy of claim 2 wherein said means to engage includes open brackets mounted to the other of said first and second components.
